(19) United States
(12) Patent Application Publication
(10) Pub. No.: US 2008/0126285 A1
(43) Pub. Date: May 29, 2008

(54) Method, Computer Program Product, And System For Automatic Software Provisioning Based On Learning History And Competency Level

(75) Inventors: Thomas J. Dinger, Sunnyvale, CA (US); Michael Roche, Dublin (IE); Sean Callanan, Dublin (IE)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/555,851

(22) Filed: Nov. 2, 2006

(51) Int. Cl. G06F 17/00

(52) U.S. Cl. 706/47

(57) ABSTRACT

Software is automatically provisioned for a user by obtaining provisioning rules that define target objects and threshold criteria for competency level and learning history. Information indicative of the user's competency level and learning history is obtained using the target objects, and the threshold criteria defined by the provisioning rules is compared with the information indicative of the user's competency level and learning history. Provided that the information indicative of the user's learning history and competency level meet the threshold criteria defined in the provisioning rules for competency and learning history, the user is provided with access to the software.

### COPYRIGHT NOTICE

A portion of the disclosure of this patent document contains or references material which may be subject to copyright protection. The copyright owner has no objection to the facsimile reproduction by any one of the patent document or the patent disclosure, as it appears in the Patent and Trademark Office patent file or records, but otherwise reserves all copyright or mask work rights whatsoever.

### FIELD OF INVENTION

This application relates to software provisioning, more particularly automatic software provisioning.

### BACKGROUND OF INVENTION

Because enterprise software systems are used by many different corporate users for many different purposes, they usually provide some level of software provisioning. A software provisioning system allows different users to access different features of a software system. There are two distinct elements in a software provisioning system: a method to determine whether a user should have access to a particular software feature and a mechanism which allows the user to access that software feature.

Different types of provisioning methods are commonly used. Those based on an “access control list” model or on a “roles and permissions” model are common. Different types of provisioning mechanisms are also common. The mechanism used typically depends on the nature of the software systems involved. For example, in a corporate network, provisioned software programs might be physically downloaded to and installed on a user's desktop computer. In a client-server environment, provisioning data might be returned to the client during the initialization process so that only the provisioned client modules will be displayed to the user. In a web application, the web pages returned to the user might only provide access to the individual product functions provisioned for that user.

Regardless of the method being used, software provisioning is predominantly managed by system administrators. Furthermore, the software provisioning process is typically based on a model in which an administrator creates certain rules to define access to software features. Most systems allow “static” rules to be created, in which case access is granted to specific users, or to predefined groups of users. Some systems also allow “dynamic” rules to be created, in which case access is granted to any users and/or groups for which an attribute or characteristic matches a defined value. In either case, these software systems typically use a corporate directory to store the user and group definitions used for provisioning.

Administration of software provisioning in existing systems, therefore, involves not only managing the rules that define access to software features, but it also involves some additional management of the corporate directory. As software systems become more complex, and as more systems are integrated with the corporate directory, an increasing amount of data must be stored in the corporate directory to support provisioning. At the same time, corporations are requiring increased levels of security for their corporate directories, which translates to additional constraints on the data that may be stored there and on access to that data. So, while software systems are increasingly dependent upon storing and accessing provisioning data in the corporate directory, their ability to store and access this data is being further constrained. This paradoxical situation can make the administration of software provisioning for existing systems quite difficult.

Furthermore, while there are many types of software features for which the existing provisioning methods are quite adequate, there are other types of software features for which the existing methods are not adequate. For example, in an existing enterprise portal, users might only be granted access to the accounting module if they are a member of the “Accountants” group in the corporate directory. The same system might allow users to access the Benefits module only after they have completed a benefits training course. This training requirement might currently be handled by adding a new group called “Trained Benefits Users” to the corporate directory. After users complete the benefits training, they are added to this group. In the best case scenario, a user will be automatically added to this group immediately after completion of the training. A more likely scenario is that they will be added to the group sometime after completion of the training. The delay in adding users to the group may be because a periodic task is handling the update to the corporate directory, or it may be because a system administrator is required to manually update the corporate directory based on training completion data. In the worst case scenario, corporate policies would forbid the addition of the new group to the corporate directory, and the software provisioning would have to be achieved by creating an individual access rule for each user who completes the training.

It follows that certain types of software provisioning would benefit from a method that does not rely upon storing data in the corporate directory or upon a manual processor.

### SUMMARY OF INVENTION

According to exemplary embodiments, a method, computer program product, and system are provided for automatically provisioning software for a user by determining whether the user should be granted access to the software based upon the user's competency and learning history. Provisioning rules are obtained, the provisioning rules defining target objects and threshold criteria for competency and learning history. Information indicative of the user's competency level and learning history are obtained using the target objects, and the threshold criteria defined by the provisioning rules is compared with the information indicative of the user's competency level and learning history. If the information indicative of the user's learning history and competency level meets the threshold criteria defined in the provisioning rules for competency and learning history, the user is provided with access to the software.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an object model for user learning history according to an exemplary embodiment.

FIG. 2 illustrates an object model for user competency according to an exemplary embodiment.

FIG. 3 illustrates an object model for a partitioning rule based on learning history according to an exemplary embodiment.

FIG. 4 illustrates an object model for a partitioning rule based on competency level according to an exemplary embodiment.

FIG. 5 illustrates an exemplary network topography in which the invention may be implemented according to an exemplary embodiment.

FIG. 6 illustrates an exemplary method for provisioning software according to an exemplary embodiment.

The detailed description explains exemplary embodiments of the invention, together with advantages and features, by way of example with reference to the drawings.

### DETAILED DESCRIPTION OF EMBODIMENTS

According to exemplary embodiments, the software provisioning technique described herein may be used instead of, or in addition to, current provisioning methods. When the provisioning of a software feature is logically based upon a user's competency level or upon some attribute of the user's learning history, the software provisioning technique described herein provides a distinct advantage over current provisioning models. Specifically, it allows the software system to handle the provisioning of a software feature automatically, without requiring the addition of a group to the corporate directory or any kind of manual administration process when a user's competency level or learning history is updated. For the purposes of this disclosure, a “software feature” could be an entire application, an entire module within an application, or an individual function within a module. The use of this new provisioning technique does require that a software system has access to the competency data and/or learning history data for the users of the system.

According to an exemplary embodiment, a software system creates provisioning rules that are based on a user's competency level and/or some attribute of a user's learning history. These provisioning rules may be created and managed by the software application being provisioned, although they may also be managed by a dedicated provisioning server. The competency level data and learning history data used may take many forms. For example, competency level data may be in a form described in detail in HR-XML Competencies Specification, version 2004-08-02, available at http://ns.hr-xml.org/2 4/. Learning history data may take the form described in the SCORM 2004 Specification, 3rd Edition, available at http://www.adlnet.gov/downloads/290.cfm.

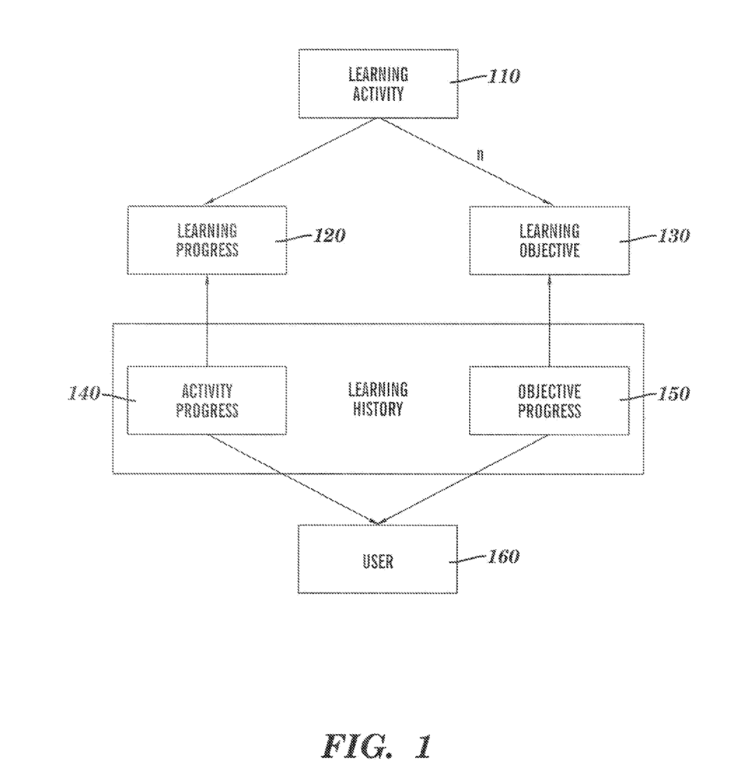

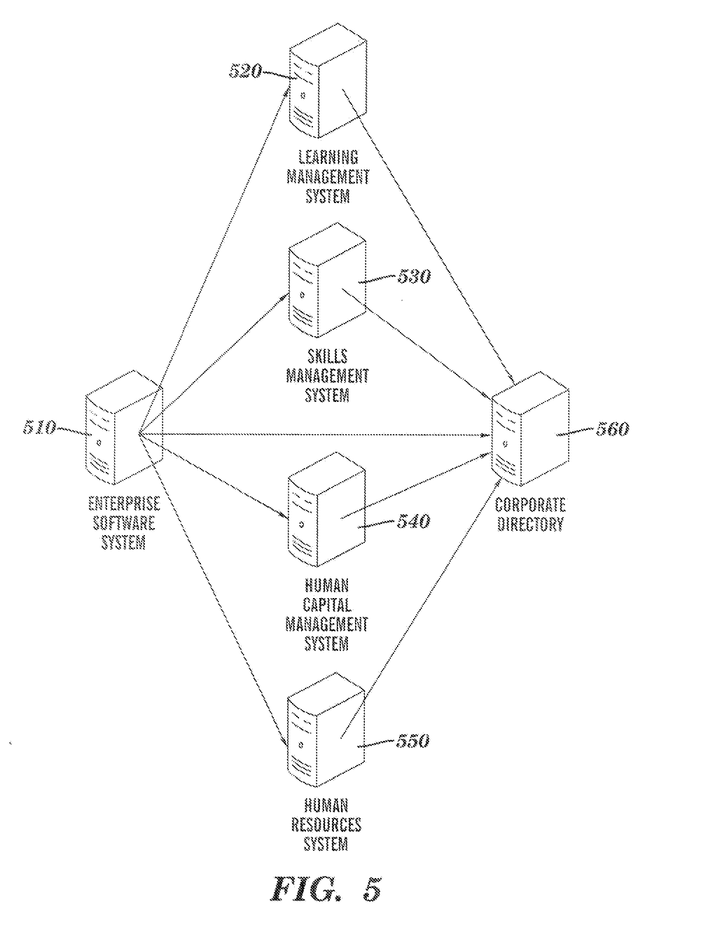

According to an exemplary embodiment, Learning History data may be maintained by a Learning Management System (see FIG. 5), like the object model for User Learning History shown in FIG. 1. In such a system, individual units of instruction are represented as a Learning Activity object 110. Each Learning Activity object 110 contains a Learning Progress object 120 for identifying its progress information, and “n” Learning Objectives 130 for identifying related objective information, where “n” is an integer. When a user/learner receives this unit of instruction, an Activity Progress object 140 and one or more Objective Progress objects 150 are created to store user 160's learning history for Learning Activity object 110.

For example, after receiving a unit of instruction, the Learning Management System might contain Activity Progress information that indicates that the learner completed the Learning Activity in four minutes and thirty seconds. The system might also contain Objective Progress information which indicates that the learner passed the Learning Activity with a score of 92%.

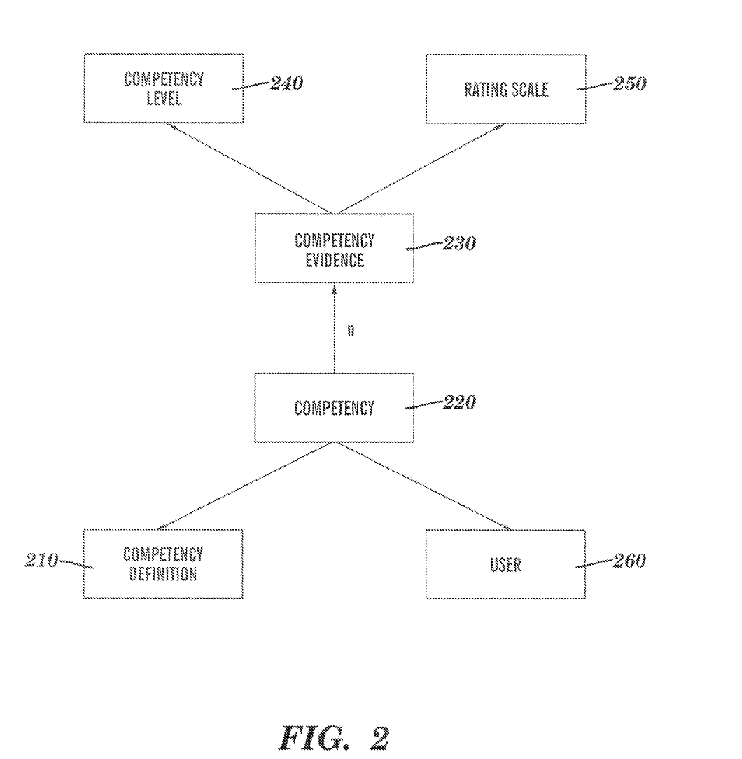

Competency data may be maintained by a Skills Management System, a Human Capital Management System, or a Human Resources System (shown in FIG. 5). In such a system, individual skills, knowledge items, interests, etc. are represented as a Competency Definition object 210 as shown in FIG. 2. A Competency object 220 is a collection of all information related to a Competency Definition object 210 for a given user 260 (which may be the same user as the user 160). Each piece of information in this collection is represented as a Competency Evidence 230 object, which contains the Competency Level 240 achieved by the user 260 and the Rating Scale 250 used to measure it.

For example, the system might contain a Competency Definition for “Accounting”. A particular user's Competency collection for Accounting might contain three items of Competency Evidence information. The first item might indicate that the user has a skill level of 11 in Forensic Accounting, on a scale of 0 to 15. The second item might indicate that the user received a rating of 4 on the National Accounting Standards examination, where the rating scale was −5 to 5. The third item might indicate that the user has an interest level of 75 in the area of Tax Accounting, on a scale of 0 to 100.

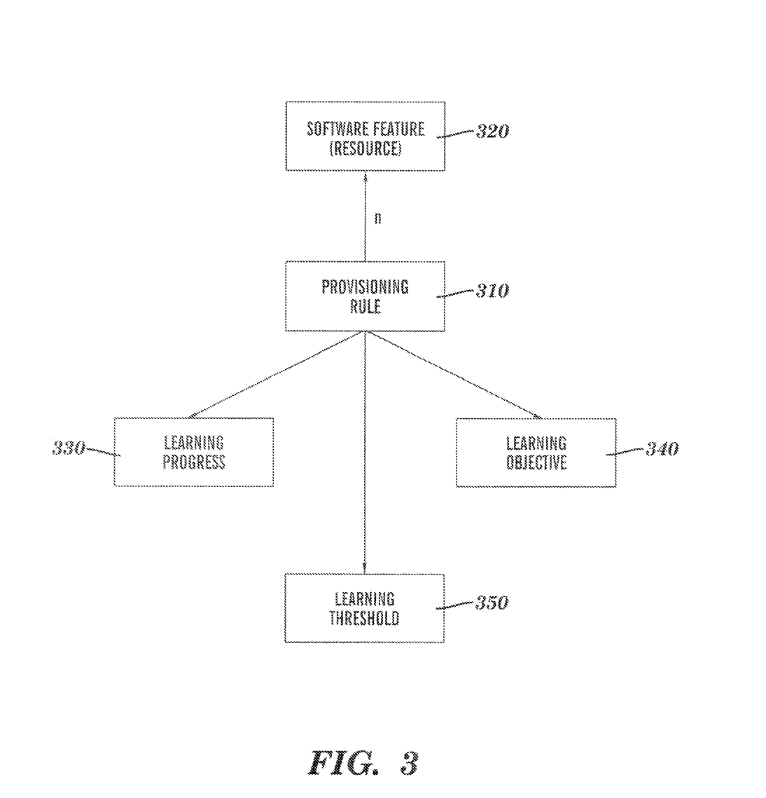

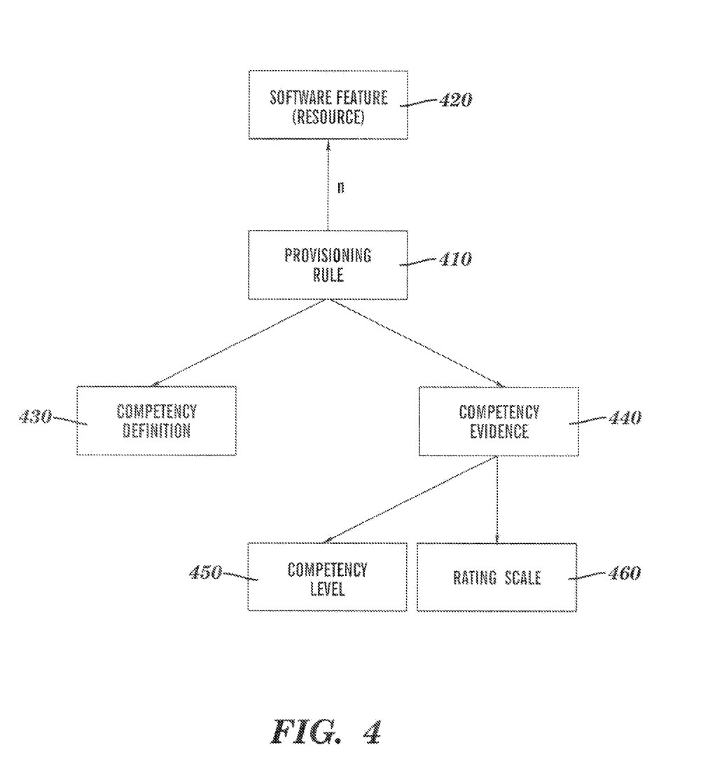

In order to use the previously described information for software provisioning, a Provisioning Rule is created (see 310, 410 in FIGS. 3 and 4, respectively). Each Provisioning Rule defines a target object and a threshold criteria, and is associated with one or more Software Features (320, 420). Using the target object, the system can retrieve the user's Competency or Learning History data from the appropriate external system. By comparing the user's data to the threshold criteria, the software system can determine whether access should be granted to the associated Software Features.

For Provisioning Rules 310 based on Learning History data, the target object is either a Learning Progress object 330 or a Learning Objective object 340, and the threshold criteria is a Learning Threshold object 340 as shown in FIG. 3. This Learning Threshold object 340 defines which attribute of the target object is to be evaluated, and the value to be used in the evaluation. For example, a Provisioning Rule might be defined which targets the Learning Objective “Accounting Test 3”, and defines a threshold criteria of 80% for the score.

For Provisioning Rules 410 based on Competency Level data, the target object is a Competency Definition object 430, and the threshold criteria is a Competency Evidence object 440 as shown in FIG. 4. This Competency Evidence object 440 defines the Competency Level 450 to be used for comparison and the Rating Scale 460 on which this value is based. For example, a Provisioning Rule might be defined which targets the Competency Definition for “Accounting”. The threshold criteria might be defined as a skill level of 10 in Forensic Accounting, on a scale of 0 to 15.

When the software system needs to determine whether a user should be granted access to a given Software Feature, it looks to see whether there are any Provisioning Rules defined for that feature. For each of these Provisioning Rules, the system compares the user's targeted Competency Level or Learning History data to the threshold value defined in the Provisioning Rule. If the user's data meets the defined threshold criteria for any of the Provisioning Rules, the user is granted access to the given Software Feature.

According to an exemplary embodiment, a method, computer program product, and system are provided for software provisioning that rely on a user's competency level and/or learning history. As shown in FIG. 5, this data does not need to be stored in a Corporate Directory 560 but may be stored elsewhere by a separate enterprise system, e.g., a Learning Management System 520, a Skills Management System 530, a Human Capital Management System 540, and/or a Human Resources System 550. The provisioning of the benefits module within the Enterprise Software System 510 does not require the addition of a group to the Corporate Directory 560, nor does it involve any kind of manual administration process for each trained user. Instead, it is based on the user's learning history, which may be obtained from the Learning Management System 520. The Enterprise Software System 510 may access the Learning Management System 520 directly to determine of a user has completed the benefits training course. For users who have completed the training course, the Enterprise Software System 510 may automatically grant access to the benefits module. Those skilled in the art will appreciate that the components shown in FIG. 5 may be implemented with any suitable computer architecture, e.g., any suitable software running on a computer or server. For example, the Enterprise Software System 510 may be implemented with a SAP Enterprise Portal, IBM Websphere Portal, the Learning Management System 520 may be implemented with a SumTotal TotalLMS, IBM Workplace Collaborative Learning System, the Skills Management System 530 may be implemented with Thomson NETg Skills Now, PeopleSoft SkillsVillage, the Human Capital Management System 540 may be implemented with Sabe Enterprise, Oracle EnterpriseOne, the Human Resources System 550 may be implemented with SAP, PeopleSoft, and the Corporate Directory 560 may be implemented with Sun iPlanet, Microsoft Active Directory.

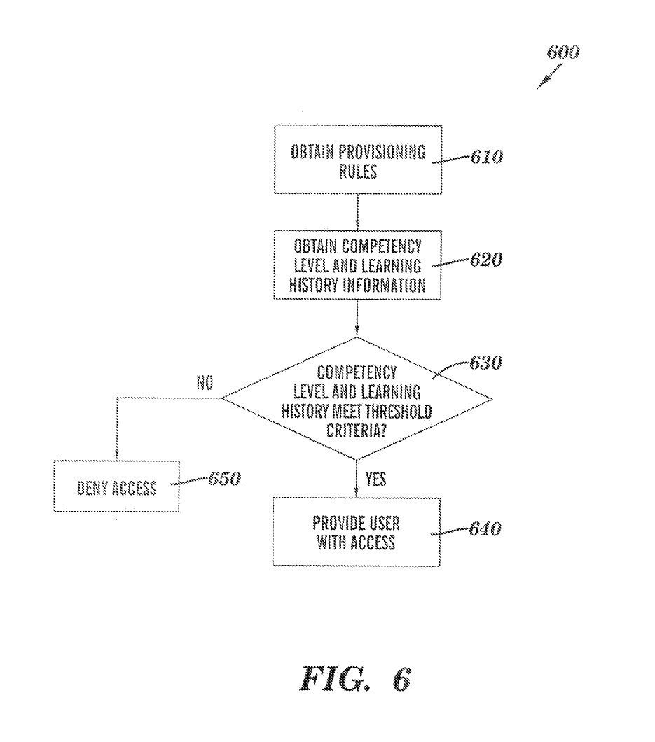

FIG. 6 illustrates a method 600 for provisioning software according to an exemplary embodiment. The method begins at step 610 at which provisioning rules are obtained. These roles may be obtained directly from the enterprise software system being provisioned. The provisioning rules define target objects and threshold criteria for competency and learning history. At step 620, information indicative of the user's competency level and learning history is obtained using the target object. At step 630, the threshold criteria defined by the provisioning rules is compared with the information indicative of the user's competency level and learning history to determine whether the information indicative of the user's learning history and competency level meet the threshold criteria defined in the provisioning rules for competency and learning history. If so, the user is provided with access to the software at step 640. Otherwise, access is denied at step 650.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to destinguish one element from another. Furthermore, the use of the terms a, an, etc. do not denote a limitation of quantity, but rather denote the presence of at least one of the referenced item.

We claim:

1. A method for automatically provisioning software for a user, comprising:
obtaining provisioning rules for provisioning software for use by a user, wherein the provisioning rules define target objects and threshold criteria for competency and learning history;
obtaining information indicative of the user's competency level and learning history using the target objects;
comparing the threshold criteria defined by the provisioning rules with the information indicative of the user's competency level and learning history; and
if the information indicative of the user's learning history and competency level meet the threshold criteria defined in the provisioning rules for competency and learning history, automatically providing the user with access to the software.

2. The method of claim 1, wherein the information indicative of the user's learning history includes activity progress information indicating that the user completed a learning activity and the amount of time the user took to complete the learning activity.

3. The method of claim 2, wherein the information indicative of the user's learning history further includes objective progress information indicating the user's score in a learning activity.

4. The method of claim 1, wherein the information indicative of the user's competency level includes items of competency evidence information that indicate skill level, ratings and interest level.

5. The method of claim 1, wherein for provisioning rules associated with learning history, the target object is either a learning progress object or a learning objective object, and the threshold criteria is a learning threshold object.

6. The method of claim 1, wherein for provisioning rules associated with competency level, the target object is a competency definition object, and the threshold criteria is a competency evidence object.

7. The method of claim 6, wherein the competency evidence object defines the competency level threshold criteria for comparison and the rating scale on which the competency level threshold criteria is based.

8. A computer program product for automatically provisioning software for a user, comprising a computer usable medium having a computer readable program, wherein the computer readable medium when executed on a computer, causes the computer to:
obtain provisioning rules for provisioning software for use by a user, wherein the provisioning rules define target objects and threshold criteria for competency and/or learning history;
obtain information indicative of the user's competency level and learning history using the target objects; and
compare the threshold criteria defined by the provisioning rules with the information indicative of the user's competency level and learning history, and
if the information indicative of the user's learning history and competency level meet the threshold criteria defined in the provisioning rules for competency and learning history, automatically provide the user with access to the software.

9. The computer program product of claim 8, wherein the information indicative of the user's learning history includes activity progress information indicating that the user completed a learning activity and the amount of time the user took to complete the learning activity.

10. The computer program product of claim 9, wherein the information indicative of the user's learning history further includes objective progress information indicating the user's score in a learning activity.

11. The computer program product of claim 8, wherein the information indicative of the user's competency level includes items of competency evidence information that indicate skill level, ratings and interest level.

12. The computer program product of claim 8, wherein for provisioning rules associated with learning history, the target object is either a learning progress object or a learning objective object, and the threshold criteria is a learning threshold object.

13. The computer program product of claim 8, wherein for provisioning rules associated with competency level, the target object is a competency definition object, and the threshold criteria is a competency evidence object.

14. The computer program product method of claim 13, wherein the competency evidence object defines the competency level threshold criteria for comparison and the rating scale on which the competency level threshold criteria is based.

15. A system for automatically provisioning software, comprising:
an enterprise software system for provisioning software for use by a user, wherein the enterprise software system obtains provisioning rules for provisioning software for use by the user, the provisioning rules defining target objects and threshold criteria for competency and learning history;
a learning management system containing information indicative of the user's learning history, wherein the enterprise software system obtains information indicative of the user's learning history from the learning management system using a target object; and
a competency management system containing information indicative of the user's competency, wherein the enterprise software system obtains information indicative of the user's competency level from the competency management system using a target object and compares the threshold criteria defined by the provisioning rules with the information indicative of the user's competency level and learning history, and
wherein if the information indicative of the user's learning history and competency level meet the threshold criteria defined in the provisioning rules for competency and learning history, the enterprise software system automatically provides the user with access to the software.

16. The system of claim 15, wherein the competency management system includes at least one of: a skills management system, a human capital management system, and a human resources system.

17. The system of claim 15, wherein the information indicative of the user's learning history includes activity progress information indicating that the user completed a learning activity and the amount of time the user took to complete the learning activity.

18. The system of claim 17, wherein the information indicative of the user's learning history further includes objective progress information indicating the user's score in a learning activity.

19. The system of claim 15, wherein the information indicative of the user's competency level includes items of competency evidence information that indicate skill level, ratings and interest level.

20. The system of claim 15, wherein for provisioning rules associated with learning history, the target object is either a learning progress object or a learning objective object, and the threshold criteria is a learning threshold object, and for provisioning rules associated with competency level, the target object is a competency definition object, and the threshold criteria is a competency evidence object.
